(19) United States
(12) Patent Application Publication
(10) Pub. No.: US 2013/0253881 A1
(43) Pub. Date: Sep. 26, 2013

(54) PROCESS FOR DETERMINING THE POSITION OF THE ROTOR OF AN ELECTRIC MACHINE

(71) Applicant: Rolf Strothmann, Saarbrucken (DE)

(72) Inventor: Rolf Strothmann, Saarbrucken (DE)

(21) Appl. No.: 13/990,119

(22) PCT Filed: Nov. 23, 2011
(86) PCT No.: PCT/DE2011/075284

§ 371 Date: May 29, 2013

(30) Foreign Application Priority Data
Dec. 3, 2010 (DE) 10 2010 053 468.4

(51) Int. Cl. G01B 7/30

(52) U.S. Cl. CPC G01B 7/30
USPC 702/151

(57) ABSTRACT

A process for determining the position, in particular the angular position, of the rotor of an electric machine in relation to the stator. A first measured value of the position is determined according to a first method. Another measured value is simultaneously determined according to at least one other measurement method, and a mean value for the position of the rotor is determined from the measured values. Preferably, the mean value is determined taking into account weighting factors that take into consideration different spreads of the measured values.

The invention pertains to a process for determining the position of the rotor, especially the angular position of the rotor, of an electric machine in relation to the stator, wherein a first measurement method is used to determine a first measurement value (α₁) of the position.

In addition to the use of sensors, especially Hall sensors, to determine the position of the rotor of electric machines, various other methods for determining these positions based on various physical processes associated with the movement of the rotor are also known. As a function of the position of the rotor, the degree of magnetization of the pole winding cores, for example, changes. The voltage of opposite polarity induced in the pole windings also changes. Both effects can be used to determine the position of the rotor.

The invention is based on the goal of creating a new process of the type indicated above, which makes it possible to determine the position of the rotor with a higher degree of accuracy, in particular an accuracy which remains uniform over a wide range of different operating states of the electric machine.

The inventive process which achieves this goal is characterized in that at least one additional measurement method, i.e., obtaining (α₁) is used simultaneously to determine an additional measurement value (α₂), and in that an average value (α) of the position of the rotor is determined from these two measurement values (α₁, α₂).

According to the invention, the position of the rotor can be advantageously determined with greater precision from several measurement values determined in different ways.

In particular, the previously mentioned value (α) can be determined advantageously with the use of weighting factors (A, B), which take into account different ranges of variation of the measurement values (α₁, α₂). Depending on these ranges, the measurement values (α₁, α₂) will then be evaluated with the help of larger or smaller weighting factors (A, B).

Variable weighting factors (A, B) are preferably used, which depend on the associated ranges of variation and thus on the operating conditions of the electric machine. Thus the value (α) can be determined with uniform precision under different sets of operating conditions.

In a preferred embodiment of the invention, the average value (α) is found in the following way. First, the values of a periodic function are formed from the measurement values (α₁, α₂); the measurement values (α₁, α₂) are inserted into this function as an argument. The function values are multiplied by the weighting factors (A, B) and then added together. Finally, the weighted sum is inserted as an argument into the inverse function of the periodic function to determine the value (α). It is an advantage of this averaging method that discontinuities in the measurement values (α₁, α₂) have no negative effect.

In a further elaboration of the invention, the weighting factors (A, B) are varied as a function of the magnitude of measurement signals representative of the measurement values (α₁, α₂). The stronger the measurement signals, the smaller the range of variation of the measurement values.

In an especially preferred embodiment of the invention, the measurement values (α₁, α₂) for the position of the rotor (7) are determined according to the first and/or at least one additional method without a position sensor on the basis of measurement signals tapped at the phase strands of the electric machine.

These measurement signals are preferably based on the degrees of magnetization of the pole winding cores and/or on voltages induced in the pole windings, both of which vary as a function of the position of the rotor.

In particular, measurement signals based on the varying degrees of magnetization of the pole winding cores are tapped at the star point of the star-wired phase strands.

In the above-mentioned embodiments, the weighting factors (A, B) are varied as a function of, for example, the level of the changes in potential (C) at the star point and on the level of the rotational speed (D) of the rotor.

The invention is explained in greater detail below on the basis of exemplary embodiments and the attached drawings, which relate to these exemplary embodiments:

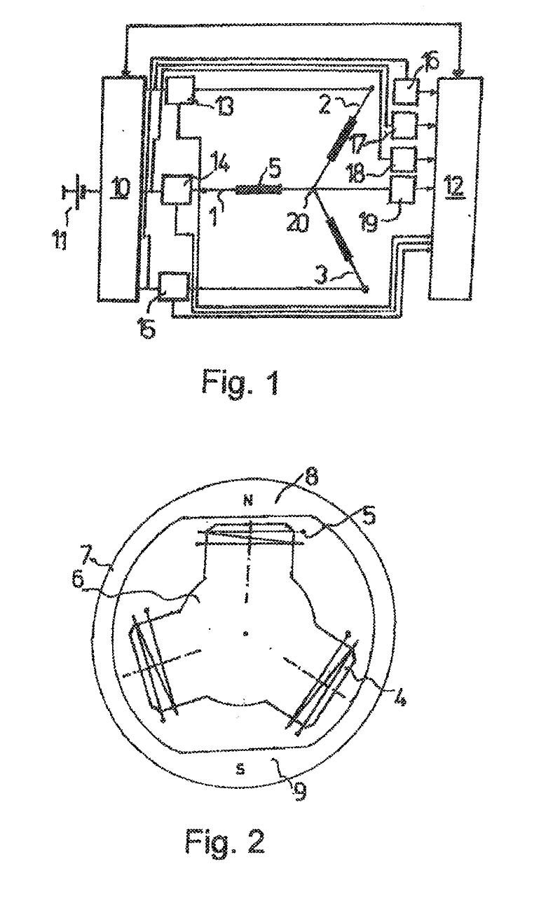

FIG. 1 shows a schematic diagram of an electric machine with a device according to the invention for determining the rotational position of the rotor;

FIG. 2 shows a cross-sectional schematic diagram of the electric machine of FIG. 1;

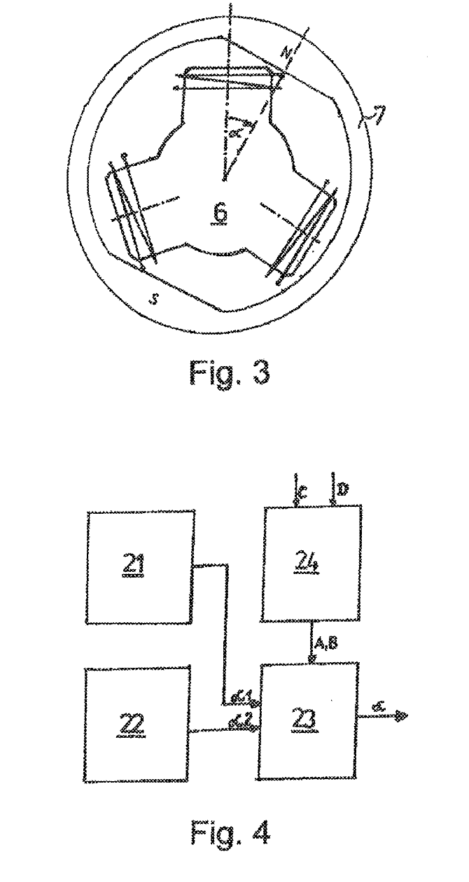

FIG. 3 shows a cross-sectional diagram of the electric machine of FIG. 2 with a rotor which has rotated by an angle a; and

FIG. 4 shows an inventive device for forming a weighted average from two measurement values (α₁, α₂) for the rotor's rotational position.

An electric machine comprises three phase strands 1, 2, 3 wired in star fashion, each with a pole winding comprising an iron core 4, on a stator 6. A rotor 7 of the external type comprises permanent magnets 8 and 9, which, in the exemplary embodiment shown here, form a single magnetic period with a north pole and a south pole.

In another exemplary embodiment, the electric machine could deviate from any of the cited features of the previously described electric machine. The number of phase currents could be greater than or less than 3, and in particular each phase strand could comprise more than one pole winding. The pole windings could be formed on the rotor, especially on an internal rotor. Instead of permanent magnets, it would also be possible to use electromagnets as the field magnets. Instead of wiring the phase strands 1, 2, 3 in star fashion, it would also be possible, alternatively or in addition, to wire them in delta fashion.

An energizing circuit 10 applies the direct voltage of a battery 11 by the pulse width modulation (PWM) method cyclically to the phase strands 1, 2, 3 in pulse-like fashion. The energizing circuit 10 is connected to a central control circuit 12, by which the rotational speed and torque of the electric machine, for example, can be controlled. The control circuit 12 is also connected to ammeters 13-15 for measuring the currents in the phase strands 1, 2, 3. Finally, the central control circuit 12 receives signals from voltmeters 16-19, which detect the potentials at the ends of the phase stands 1, 2, 3 and the potential at the star point 20.

As FIGS. 2 and 3 illustrate, the magnetic field of the rotor 7 permeates the pole windings 5 to different degrees depending its rotational position relative to the stator 6. The degrees of magnetization of the iron cores 4 also differ correspondingly. Over one-half of a magnetic period, there is a unique functional relationship in each case between the degrees of magnetization, i.e., the associated slope of the hysteresis function, and the rotational angle a. On the basis of the position-dependent degrees of magnetization of the pole winding cores or on the basis of the inductances of the phase strands determined by the degrees of magnetization, it is possible to determine the angular position a of the rotor 7 as described in DE 10 2006 046 437 A1, which is included here by reference.

The pulses applied as part of the PWM method to the phase strands and/or the separately applied measurement pulses lead, as a result of the different inductances of the phase strands, to characteristic potential jumps at the star point 20, which the voltmeter 19 detects and the control circuit 12 then evaluates, possibly under consideration of the currents determined by the ammeters 13-15.

The control circuit 12 also receives signals from the voltmeters 16-18 for evaluation. All of the received signals are determined and evaluated continuously within very short time intervals, during which the angular position of the rotor experiences practically no change. From the voltages and currents detected continuously in this way with the help of the measuring devices 13-19, it is possible, under consideration of the applied voltage pulses, to calculate the induced voltages of opposite polarity and thus to acquire measurement signals which represent the angular position.

According to FIG. 4, the control circuit 12 comprises a first evaluation device 21, which, based on the position-dependent degrees of magnetization of the pole winding cores 4, supplies a first measurement value α₁ for the angular position of the rotor 7. The control circuit 12 also comprises a second evaluation device 22 for (approximately) simultaneous determination of the second measurement value α₂, which is based on the voltages induced in the phase strands 1, 2, 3, by the rotation of the rotor 7.

The control circuit 12 also comprises a mixing device 23, which receives the measurement values α₁, α₂, and which is connected to a weighting device 24, which provides weighting factors A, B. From the two measurement values α₁, α₂, the mixing device 23 forms an average value α under consideration of the weighting factors A, B. In the exemplary embodiment shown here, the averaging is carried out in such a way that the determined value a satisfies the following equations:

sin α=A sin α₁+B sin α₂ (1)

cos α=A cos α₁+B cos α₂ (2).

For the average value α, it follows from (1) and (2) that:

α=arctan [(A sin α₁+B sin α₂)/(A cosα₁+B cos α₂)] (3).

The weighting device 24 adjusts the weighting factors A, B as a function of the rotational speed D of the rotor 7 and the amplitude C of the previously mentioned potential jumps at the star point 20.

At large amplitudes C of the potential jumps at the star point, that is, when there are large differences between the inductances of the phase strands 1, 2, 3, and when the rotational speed is low, i.e., when the induced voltages are low, A>B is selected, and thus the measurement value α₁ determined by the first method is accentuated. As the speed D increases, the weighting factor B becomes correspondingly larger and A smaller.

1-10. (canceled)

11. A process for determining a position of a rotor, especially the rotational position of the rotor, of an electric machine in relation to a stator, the process comprising the steps of: determining a first measurement value (α₁) of the position by a first measurement method; simultaneously determining a second measurement value (α₂) by a second measuring method; and determining an average value (α) of the position of the rotor from the two measurement values.

12. The process according to claim 11, including determining the average value (α) taking into consideration different weighting factors (A, B), which take into account ranges of variation of the measurement values (α₁, α₂).

13. The process according to claim 12, including forming a periodic function from the measurement values (α₁, α₂) as argument values; function values, multiplied by the weighting factors, being added together; and, for determining of the average value (α) from the weighted sum as an argument, a value of an inverse function of the periodic function is formed.

14. The process according to claim 13, including determining the average value (α) in the following manner:
A sin α₁+B sin α₂=sin α
A cos α₁+B cos α₂=cos α
tan α=(A sin α₁+B sin α₂)/(A cos α₁+B cos α₂).
α=arctan[(A sin α₁+B sin α₂)/(A cos α₁+B cos α₂)].

15. The process according to claim 12, including using variable weighting factors (A, B) dependent on associated ranges of variation of the measurement values (α₁, α₂).

16. The process according to claim 15, including varying the weighting factors (A, B) as a function of magnitude of measurement signals representative of the measurement values (α₁, α₂).

17. The process according to claim 12, wherein determination of the measurement values (α₁, α₂) for the position of the rotor according to the first and/or the second measuring method takes place without a position sensor based on measurement signals which are tapped at phase strands of the electric machine.

18. The process according to claim 17, wherein the tapped measurement signals are based on degrees of magnetization of pole winding cores and/or on voltages of opposite polarity induced in the pole windings, both of which vary as a function of the position of the rotor.

19. The process according to claim 18, wherein measurement signals based on the varying degrees of magnetization of pole winding cores are tapped at a star point of star-wired phase strands.

20. The process according to claim 19, including varying the weighting factors (A, B) as a function of a maximum level of potential changes at the star point and on a level of rotational speed of the rotor.
